(19) United States
(12) Patent Application Publication
(10) Pub. No.: US 2005/0007321 A1
(43) Pub. Date: Jan. 13, 2005

(54) Reduced reverse bias in organic light emitting diode displays

(76) Inventor: Jeffrey A. Schuler, San Jose, CA (US)

Correspondence Address: Siemens Corporation;Attn: Elsa Keller, Legal Administrator, Intellectual Property Department, 170 Wood Avenue South, Iselin, NJ, 08830, US

(21) Appl. No.: 10/610,859

(22) Filed: Jun. 30, 2003

(51) Int. Cl. G09G 3/32

(52) U.S. Cl. 345/82

(57) ABSTRACT

One embodiment of this invention pertains to an OLED display that includes: multiple row lines and multiple column lines where the multiple row lines intersect the multiple column lines. The display also includes multiple elements and the multiple elements are at the intersections of the multiple row lines and the multiple column lines and are coupled to the multiple row lines and the multiple column lines. The display further includes a control unit that is coupled to the multiple row lines and the multiple column lines. The control unit selects one of the row lines and also selects for activation one or more of the multiple elements that are coupled to the selected row line by selecting one or more of the multiple column lines that are coupled to the one or more of the multiple elements that are to be activated. During a horizontal scanning period, the one or more nonselected row lines are floated and the zero or more nonselected column lines are floated. Then, during this period, the selected row line is coupled to a ground potential, and the one or more selected column lines are coupled to current supplies. Prior to the horizontal scanning period, a blanking period is used to reverse bias all of the elements of the display. By driving the OLED display in this manner, the voltage generated by voltage supplies that are used to reverse bias the elements can be reduced.

### BACKGROUND OF THE INVENTION

Some of the advantages of an organic light emitting diode (“OLED”) display include low power dissipation and good image quality. The OLED display can be arranged, for example, such that the OLED elements are in a matrix pattern and anodes of each element are coupled to column lines and cathodes of each element are coupled to row lines. Voltage or current can be applied to the elements via the row and column lines. In order to activate an element, a current supply can be used to charge a column line corresponding to that element to a predetermined voltage (“V_{f}”) (the V_{f} is greater than or equal to a threshold illumination voltage (“Vₜ”)) while the corresponding row line is grounded so that the element emits at the desired luminance.

The OLED display can be driven using, for example, passive matrix addressing or active matrix addressing. FIG. 1 shows a prior art passive matrix OLED display 103. In FIG. 1, a control unit 106 is coupled to an anode line drive unit 109, an anode line reset unit 115, and a cathode line drive unit 112. The control unit 106 directs the anode line drive unit 109, the anode line rest unit 115, and the cathode line drive unit 112 to display an image in accordance with a video signal supplied by a video generation unit (not shown). In FIG. 1, “n” row lines B₁ to Bₙ are arranged in parallel to each other so as to extend in the lateral direction and these lines are coupled to the cathodes of the elements E_{1,1} to E_{m,n}. In addition, “m” column lines A₁ to Aₘ are arranged parallel to each other so as to extend in the longitudinal direction and these lines are coupled to the anodes of the elements E_{1,1} to E_{m,n}. The row lines B₁ to Bₙ are coupled to a cathode line drive unit 112, and the column lines A₁ to Aₘ are coupled to an anode line drive unit 109 and an anode line reset unit 115. Each of the switches S_{B1} to S_{Bn} selectively couple the row lines B₁ to Bₙ either to a reverse bias voltage supply, Vcc (the reverse bias voltage is, e.g., 8 volts), or to a ground potential (e.g., 0 volt). Each of the switches S_{A1} to S_{Am} selectively couple the column lines A₁ to Aₘ to a constant current supply, and each of the switches S_{C1} to S_{Cm} selectively couple the column lines A₁ to Aₘ to the ground potential.

The control unit 106 sends a scanning line selection control signal to the cathode line drive unit 112 to select one of the row lines B₁ to Bₙ corresponding to a horizontal scanning period of a video signal and the switch corresponding to the selected row line couples that line to ground potential (only one row line is selected during a particular horizontal scanning period). For example, in FIG. 1, assume that only the element E_{1,1} is to emit light during the horizontal scanning period in which the row line B₁ is selected. In this case, the selected row line B₁ is coupled to ground potential via the switch S_{B1}. The cathode line drive unit 112 via the corresponding switches couples all the non-selected row lines to the reverse bias voltage. Specifically in FIG. 1, the switches S_{B2} through S_{Bn} couple the non-selected row lines B₂ to Bₙ to the reverse bias voltage. The reverse bias voltage is applied to prevent illumination of the nonselected elements; these elements may illuminate due to crosstalk caused by switching transients through the capacitance of the pixel.

The control unit 106 produces a drive control signal indicating a period of time during which zero or more elements connected to the selected row line is illuminated in accordance with the information provided by the video signal. As directed by the drive control signal, the anode line drive unit 109, via the switches S_{A1} to S_{Am}, couple the elements that are to be illuminated to the constant current supplies (e.g., the constant current supplies provides enough current to illuminate the element, i.e., the voltage across the element is greater than or equal to Vₜ). Referring to the example shown in FIG. 1, since element E_{1,1} is to be illuminated, the column line A₁ is coupled to the constant current supply via the switch S_{A1}. Since element E_{1,1} is to be illuminated, the control unit 106 directs the anode line reset unit 115 to float the switch S_{C1} (e.g., the switch S_{C1} is floating if it is left open, e.g., it is not coupled to a current supply, a voltage supply, or a ground potential). Since E_{2,1} through E_{m,1} are not to be illuminated, the control unit 106 directs the anode line drive unit 109 to float the column lines A₂ to Aₘ via the switches S_{A2} through S_{Am}, and also directs the anode line reset unit 115 to couple the non-selected column lines (i.e., the column lines A₂ through Aₘ) to ground potential via the corresponding switches S_{C2} through S_{Cm}.

In the example shown in FIG. 1, the element E_{1,1} is forward biased and thus illuminates light. The elements E_{1,2} through E_{1,n} and E_{2,1} through E_{m,1} do not emit light since the voltage across these elements are less than the threshold illumination voltage, Vₜ (the threshold illumination voltage is the voltage at which the element begins to emit undesirable light; e.g., the Vₜ ranges from 1.5 to 2 volts). The electric charge flowing through these elements are stored in the capacitive component of the elements. The elements E2,2 to E_{m,n} are reverse biased and thus do not emit light. The reverse bias voltage prevents nonselected elements from illuminating due to crosstalk, however, this voltage does not contribute to the illumination of the elements. Since the reverse bias voltage does not contribute directly to the illumination intensity of the elements, it would be desirable to reduce the reverse bias voltage without noticeably decreasing the quality of the display due to cross-talk. By decreasing the reverse bias voltage, the amount of current drawn from the battery is reduced thus reducing power consumption by the display. A lower reverse bias voltage can also increase the lifetime of the elements of the display.

For the foregoing reasons, there exists a need to reduce the reverse bias voltage within a passive matrix display.

### SUMMARY

An embodiment of an OLED display is described. The display includes multiple first lines and multiple second lines, and the second lines intersect the first lines. The display also includes multiple elements and these elements are at intersections of the first lines and the second lines. The elements are coupled to the first lines and the second lines. A control unit is coupled to the first lines and the second lines, and selects one of the first lines and selects for activation one or more of the elements that are coupled to the selected first line by selecting one or more of the second lines that are coupled to the one or more of elements that are to be activated. During a horizontal scanning period, one or more of the first lines that are not selected are floated and zero or more of the second lines that are not selected are floated.

An embodiment of a method to drive an OLED display is described. The display includes multiple elements on a substrate, and these elements are coupled to multiple first lines and multiple second lines. The elements are at intersections of the first lines and the second lines. This embodiment of the method includes, first, selecting one of the first lines, and then selecting for activation one or more of the elements that are coupled to the selected first line by selecting one or more of the second lines that are coupled to the one or more of the elements that are to be activated. Then, one or more of the first lines that are not selected are floated, and zero or more of the second lines that are not selected are floated.

### BRIEF DESCRIPTION OF THE DRAWINGS

FIG. 1 shows a prior art passive matrix OLED display.

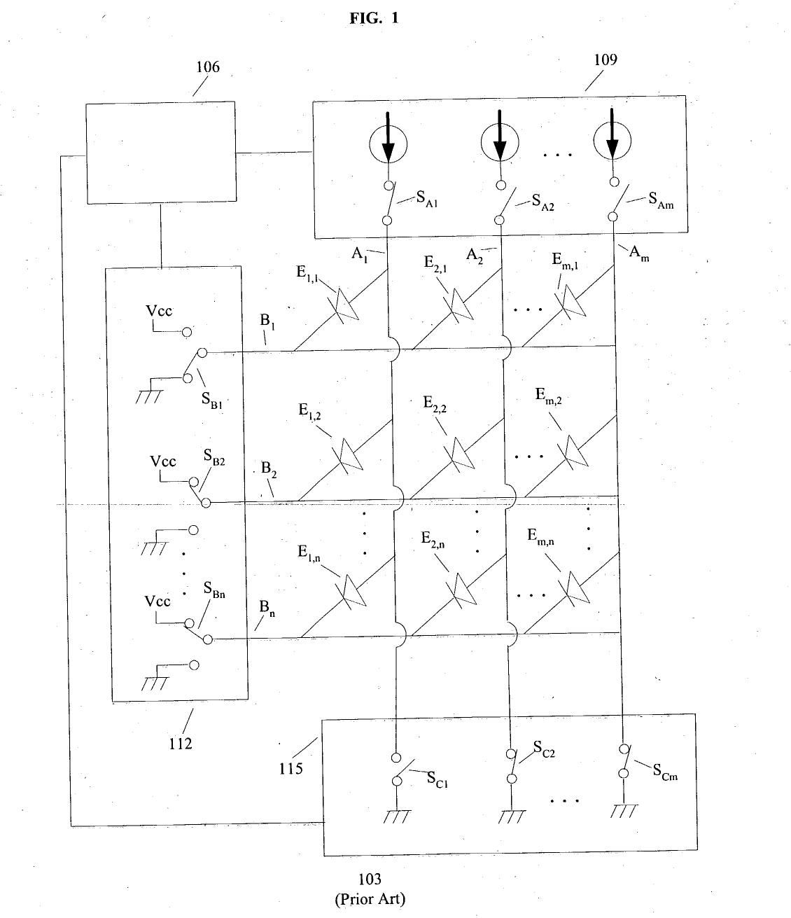

FIG. 2 shows a passive matrix OLED display according to an embodiment of the present invention during the blanking period.

FIG. 3 shows a passive matrix OLED display according to an embodiment of the present invention during the horizontal scanning period.

FIG. 4 shows a timing diagram for an embodiment of the passive matrix OLED display according to the present invention.

FIG. 5 shows an embodiment of a process to drive the passive matrix OLED display according to the present invention.

### DETAILED DESCRIPTION

The value of the reverse bias voltage is constrained by, for example, the following:
Vcc1>V_{f}−Vₜ, and
Vcc2<Vₜ,
where Vcc1 is the cathode voltage applied to the nonselected row lines, and Vcc2 is the anode voltage applied to the nonselected column lines.

In addition, the reverse bias voltage can be defined as: Vcc1−Vcc2. By substituting the two constraints specified earlier into this formula, the minimum reverse bias voltage can be defined as: V_{f}−2*Vₜ.

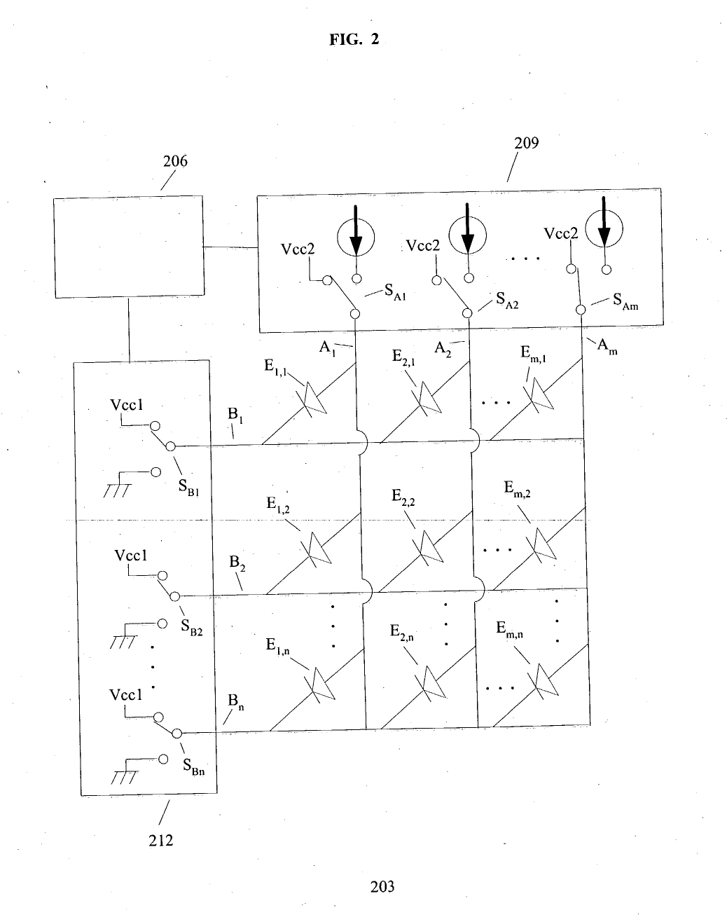

When driving a passive matrix OLED display, between each of the horizontal scanning periods is a blanking period during which all of the elements are reverse biased. As a result, prior to the beginning of each horizontal scanning period, each of the elements are reverse biased. Reverse biasing the elements during each blanking period prevents nonselected elements from emitting light during the next horizontal scanning period. In addition, the blanking period prevents a partial image during the next horizontal scanning period of the image displayed during the previous horizontal scanning period. FIG. 2 shows a passive matrix OLED display 203 according to an embodiment of the present invention during the blanking period. In FIG. 2, a control unit 206 is coupled to an anode line drive unit 209, and a cathode line drive unit 212. In FIG. 2, “n” row lines B₁ to Bₙ are arranged in parallel to each other so as to extend in the lateral direction and these lines are coupled to the cathodes of the elements E_{1,1} to E_{m,n}. In addition, “m” column lines A₁ to Aₘ are arranged parallel to each other so as to extend in the longitudinal direction and these lines are coupled to the anodes of the elements E_{1,1} to E_{m,n}. The row lines B₁ to Bₙ are coupled to a cathode line drive unit 212, and the column lines A₁ to Aₘ are coupled to an anode line drive unit 209. Each of the switches S_{B1} to S_{Bn} selectively couple the row lines B₁ to Bₙ either to a reverse bias voltage supply, Vcc1 (Vcc1 can be, e.g., 7.5 volts), or to a ground potential (e.g., 0 volt). The switches S_{A1} to S_{Am} selectively couple the corresponding column lines A₁ to Aₘ to a constant current supply (e.g., the constant current supply generates a current to drive a voltage across a corresponding element above a threshold illumination voltage) or to a column low voltage supply (e.g., the column low voltage is approximately equal to the threshold illumination voltage; the column low voltage can be, for example, 1.5 volts or 2 volts).

During the blanking period, all of the elements are reverse biased, i.e., all of the row lines are coupled to the reverse bias voltage and all of the columns lines are coupled to the column low voltage supply. Specifically, in FIG. 2, during the blanking period, all of the row lines B₁ through Bₙ are coupled to the reverse bias voltage supply, Vcc1. In addition, all of the column lines A₁ through Aₘ are coupled to the column low voltage supply, Vcc2. By reverse biasing the elements prior to the next horizontal scanning period, the nonselected row lines and column lines can be floated during the next horizontal scanning period without having those nonselected elements unintentionally emit light and thus diminish the image quality.

After the blanking period completes, the display enters a horizontal scanning period. During the horizontal scanning period, one of the row lines B₁ to Bₙ is selected and one or more elements coupled to the selected row line can be activated by selecting one or more of the column lines that are coupled to the one or more elements that are to be activated. During the horizontal scanning period, the nonselected row lines are floated and the nonselected column lines are floated. In addition, the one or more elements that are to be activated are forward biased by, for example, coupling the selected row line to a ground potential, and coupling the selected one or more column lines to corresponding one or more current supplies that supply a current to drive a voltage across a corresponding element above a threshold illumination voltage.

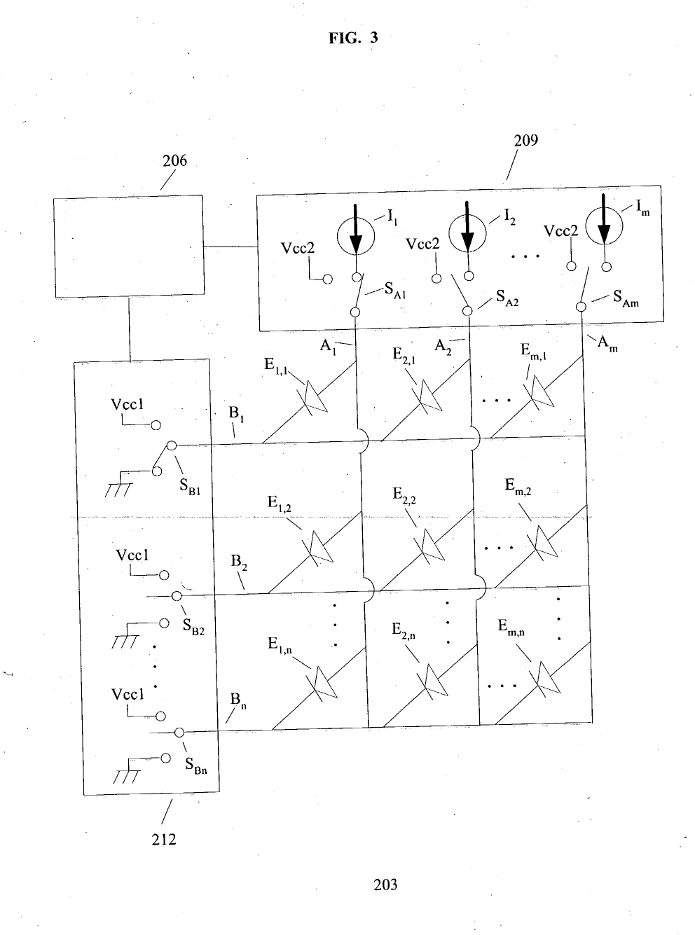

FIG. 3 shows a passive matrix OLED display 203 according to an embodiment of the present invention during the horizontal scanning period. In the example shown in FIG. 3, the control unit 206 selects row line B₁ as the selected row line during this horizontal scanning period. In this example, only the element E_{1,1} is to emit light during this horizontal scanning period so the control unit 206 activates element E_{1,1} by selecting the column line coupled to the element E_{1,1}. Here, the column line coupled to the element E_{1,1} is column line A₁. The control unit 206 sends a control signal to the cathode line drive unit 212 to float all of the nonselected row lines. Specifically, row lines B₂ to Bₙ are floated by not coupling the corresponding switches S_{B2} to S_{Bn} either to the reverse bias voltage supply Vcc1 or the ground potential. In addition, the control unit 206 sends a control signal to the anode line drive unit 209 to float all of the nonselected column lines. Specifically, column lines A₂ to Aₘ are floated by not coupling the corresponding switches S_{A2} to S_{Am} either to the current supplies I₂ to Iₘ or to the column low voltage supply, Vcc2. Then, the control unit 206 sends a scanning line selection control signal to the cathode line drive unit 212 to instruct it to couple the selected row line B₁ to ground potential via the switch S_{B1}. In addition, the control unit 206 sends a drive control signal to the anode line drive unit 209 to instruct it to couple the selected column line A₁ to the current supply I₁ via the switch S_{A1}.

By reverse biasing all the elements during the blanking period and then floating the nonselected row lines and the nonselected column lines during the horizontal scanning period, the reverse bias voltage used can be less than the reverse bias voltage used in a typical passive matrix display (i.e., the reverse bias voltage generated by the corresponding voltage supplies Vcc1 can be less than the typical reverse bias voltage generated by the corresponding voltage supplies in the typical passive matrix display). For example, in the typical passive matrix display, if the V_{f} is 10 volts and the Vₜ is 2 volts, then the reverse bias voltage Vcc1 is set to 8 volts. By reverse biasing the elements during the blanking period and then floating the nonselected row lines and column lines during the horizontal scanning period, the reverse bias voltage can be reduced to, for example, 7.5 volts while providing substantially comparable display image quality. The reverse bias voltage of 7.5 volts violates the constraint that “Vcc1>V_{f}−Vₜ”, however, this violation is acceptable due to the blanking period and the floating of the nonselected column lines and row lines during the horizontal scanning period. Reducing the reverse bias voltage reduces the current drawn from the power supply (e.g., the battery). By floating the nonselected row lines and the nonselected column lines during the horizontal scanning period, the amount of time that the elements of the display are reverse biased is reduced thus decreasing the likelihood of pixel shorts and increasing the lifetime of the elements of the display.

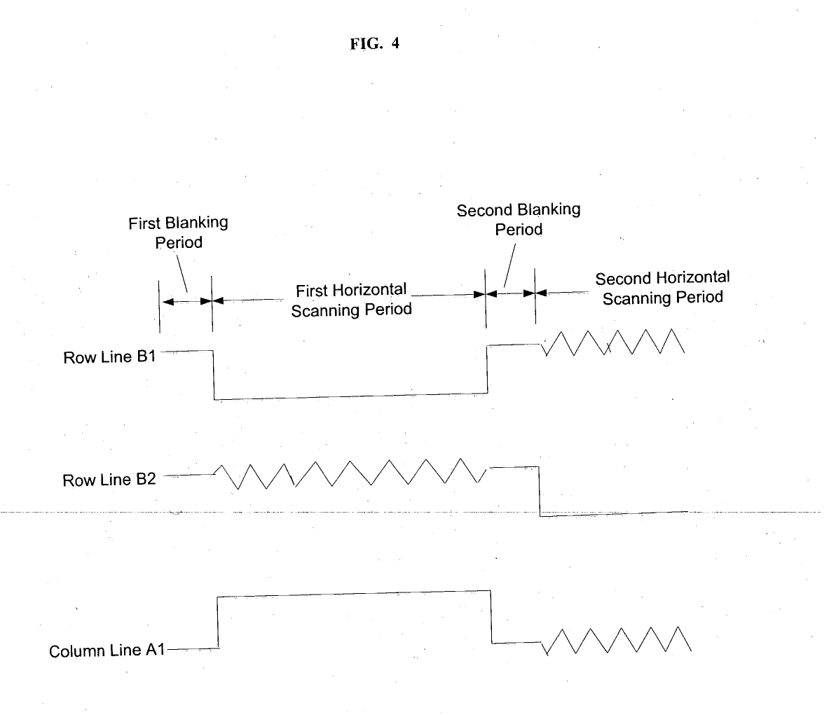

FIG. 4 shows a timing diagram for an embodiment of the passive matrix OLED display 203 according to the present invention. During a first blanking period, all of the elements E_{1,1} to E_{m,n} are reverse biased. When reverse biased, all of the row lines (including row line B₁ and row line B₂) are coupled to the reverse bias voltage (e.g., 7.5 volts) and all of the column lines (including column line A₁) are coupled to the column low voltage (e.g., 2 volts). After the first blanking period, the display enters a first horizontal scanning period. During the first horizontal scanning period, assume that only the element E_{1,1} is to be activated. In this case, during the first horizontal scanning period, all of the nonselected row lines (including row line B₂) are floated and all of the nonselected column lines are floated. Then, during this period, the row line B₁ (i.e., the selected row line) is coupled to ground potential and the column line A₁ (i.e., the selected column line) is coupled to the constant current supply. By reverse biasing all the elements during the first blanking period, and floating the nonselected row lines and column lines during the first horizontal scanning period, the reverse bias voltage used can be less than that used in a typical passive matrix OLED display while still providing substantially the same image quality.

After the first horizontal scanning period and prior to the beginning of the second horizontal scanning period, a second blanking period is used to reverse bias all of the elements. The second blanking period prevents nonselected elements from emitting light when their corresponding row lines and column lines are floated during the second horizontal scanning period, and also prevents a partial image during the second horizontal scanning period of an image displayed during the first horizontal scanning period. During this second blanking period, all of the row lines (including row line B₁ and row line B₂) are coupled to the reverse bias voltage (e.g., 7.5 volts) and all of the column lines (including column line A₁) are coupled to the column low voltage (e.g., 2 volts). After the second blanking period, the display enters a second horizontal scanning period. During the second horizontal scanning period, assume that the selected row line is row line B₂ and the element E_{1,1} is not to be activated. In this case, during the second horizontal scanning period, all of the nonselected row lines (including row line B₁) are floated and all of the nonselected column lines (including column line A₁) are floated. Then, during this period, the row line B₂ (i.e., the selected row line) is coupled to ground potential.

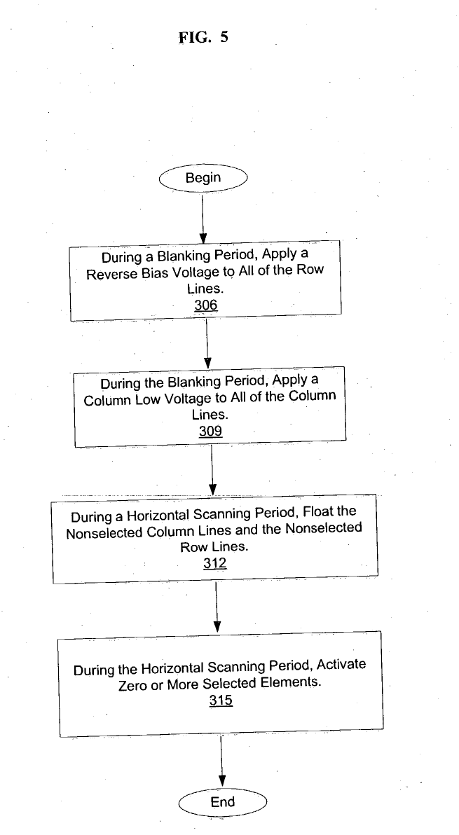

FIG. 5 shows an embodiment of a process to drive the passive matrix OLED display 203 according to the present invention. The OLED display 203 is shown in FIG. 3 in which multiple elements E_{1,1} to E_{m,n} are fabricated on a substrate and these elements are at intersections between the multiple row lines B₁ to Bₙ and the multiple column lines A₁ to Aₘ. In block 306, during a blanking period, a reverse bias voltage less than that typically used to reverse bias an OLED is applied to all of the row lines. For example, the reverse bias voltage used in the display 203 can be 7.5 volts while the reverse bias voltage used in a typical prior art passive matrix OLED display is 8 volts. In block 309, during the blanking period, a column low voltage is applied to all of the column lines. The column low voltage can be, for example, 2 volts. After the blanking period completes, the display 203 enters a horizontal scanning period. In block 312, during the horizontal scanning period, the nonselected row lines and the nonselected column lines are floated. Then, in block 315, the zero or more selected elements coupled to the selected row line are activated. These zero or more selected elements are activated by grounding the selected row line, and applying a voltage higher than a threshold illumination voltage to the zero or more selected column lines that are coupled to the zero or more elements that are to be activated.

As any person of ordinary skill in the art of OLED display development will recognize from the description, figures, and examples that modifications and changes can be made to the embodiments of the invention without departing from the scope of the invention defined by the following claims.

1. An organic light emitting diode (“OLED”) display, comprising:
a plurality of first lines;
a plurality of second lines, said plurality of second lines intersect said plurality of first lines;
a plurality of elements, said plurality of elements are at said intersections of said plurality of first lines and said plurality of second lines, said plurality of elements coupled to said plurality of first lines and said plurality of second lines; and
a control unit, coupled to said plurality of first lines and said plurality of second lines, said control unit selects a particular one of said plurality of first lines and selects for activation one or more of said plurality of elements that are coupled to said selected first line by selecting one or more of said plurality of second lines that are coupled to said one or more of said plurality of elements that are to be activated,
wherein, during a horizontal scanning period, one or more of said plurality of first lines that are not selected are floated and zero or more of said plurality of second lines that are not selected are floated.

2. The display of claim 1 wherein, during said horizontal scanning period, said selected first line is coupled to a ground potential, and said one or more of said plurality of second lines that are selected are coupled to one or more current supplies that each supply a current to drive a voltage across a corresponding element above a threshold illumination voltage.

3. The display of claim 2 wherein said one or more of said plurality of first lines that are not selected and said zero or more of said plurality of second lines that are not selected are floated prior to coupling said selected first line to a ground potential and prior to coupling said selected one or more of said plurality of second lines to said one or more current supplies that each supply said current to drive said voltage across said corresponding element above said threshold illumination voltage.

4. The display of claim 1 further comprising
a plurality of first voltage supplies, said plurality of first voltage supplies selectively coupled to corresponding ones of said plurality of first lines,
wherein each of said plurality of first voltage supplies generates less voltage than a typical voltage used to reverse bias an OLED.

5. The display of claim 4 wherein said plurality of first voltage supplies generate approximately 0.5 volts less than said typical voltage.

6. The display of claim 5 wherein said plurality of first voltage supplies generate approximately 7.5 volts.

7. The display of claim 1 further comprising
a plurality of second voltage supplies, said plurality of second voltage supplies selectively coupled to said plurality of second lines,
wherein said plurality of second voltage supplies supply approximately two (2) volts.

8. The display of claim 1 wherein said one or more of said plurality of first lines that are not selected and said zero or more of said plurality of second lines that are not selected are -floated when said one or more of said plurality of first lines and said zero or more of said plurality of second lines are not coupled to any one of: a voltage supply, a current supply, or a ground potential.

9. The display of claim 1 wherein said control unit, during a blanking period, reverse biases said plurality of elements.

10. The display of claim 9 wherein reverse biasing said plurality of elements includes coupling said plurality of first lines to corresponding ones of a plurality of first voltage supplies, each of said plurality of first voltage supplies generate less voltage than a typical voltage used to reverse bias an OLED, and coupling said plurality of second lines to a plurality of second voltage supplies, each of said plurality of second voltage supplies generate approximately a threshold illumination voltage.

11. The display of claim 10 wherein said blanking period occurs prior to said horizontal scanning period.

12. A method to drive an organic light emitting diode (“OLED”) display, said display includes a plurality of elements on a substrate, said plurality of elements are coupled to a plurality of first lines and a plurality of second lines, wherein said plurality of elements are at intersections of said plurality of first lines and said plurality of second lines, said method, comprising:
selecting a particular one of said plurality of first lines;
selecting for activation one or more of said plurality of elements that are coupled to said selected first line by selecting one or more of said plurality of second lines that are coupled to said one or more of said plurality of elements that are to be activated; and
floating one or more of said plurality of first lines that are not selected, and floating zero or more of said plurality of second lines that are not selected.

13. The method of claim 12 further comprising
grounding said selected first line, and
applying a current to said selected one or more of said plurality of second lines to drive a voltage across corresponding one or more elements above a threshold illumination voltage.

14. The method of claim 13 wherein
floating said one or more of said plurality of first lines that are not selected and floating said zero or more of said plurality of second lines that are not selected occurs prior to grounding said selected first line and applying said current to said selected one or more of said plurality of second lines to drive said voltage across said corresponding one or more elements above said threshold illumination voltage.

15. The method of claim 13 further comprising
during a blanking period, reverse biasing said plurality of elements.

16. The method of claim 15 wherein said blanking period occurs prior to floating said one or more of said plurality of first lines that are not selected and floating said zero or more of said plurality of second lines that are not selected.

17. The method of claim 15 wherein reverse biasing said plurality of elements includes
applying to said plurality of first lines less voltage than a typical voltage used to reverse bias an OLED, and
applying approximately a threshold illumination voltage to said plurality of second lines.

18. The method of claim 17 wherein said less voltage than said typical voltage used to reverse bias said OLED is a voltage approximately 0.5 volts less than said typical voltage.

19. The method of claim 18 wherein said voltage approximately 0.5 volts less than said typical voltage is a voltage approximately 7.5 volts.

20. The method of claim 12 wherein floating said one or more of said plurality of first lines that are not selected and floating said zero or more of said plurality of second lines that are not selected includes not coupling said one or more of said plurality of nonselected first lines and said zero or more of said plurality of nonselected second lines to any one of: a voltage supply, a current supply, or a ground potential.
